(19) United States
(12) Patent Application Publication
(10) Pub. No.: US 2015/0060453 A1
(43) Pub. Date: Mar. 5, 2015

(54) APPARATUS WITH VESSEL AND MOUNT

(71) Applicant: ALKIPOPS INC., Glendale, CA (US)

(72) Inventors: Arezo Nora Rahimi, Glendale, CA (US); Nairi Yerjanik Markarian, Glendale, CA (US)

(73) Assignee: ALKIPOPS INC., Glendale, CA (US)

(21) Appl. No.: 14/017,046

(22) Filed: Sep. 3, 2013

(51) Int. Cl. B65D 83/38; B65D 41/16; B65D 41/40; B65D 41/04

(52) U.S. Cl. CPC B65D 83/38; B65D 41/04; B65D 41/16; B65D 41/40
USPC 220/265; 220/288; 220/796; 220/200

(57) ABSTRACT

Various apparatuses are disclosed. An apparatus may include a vessel configured to hold liquid, a cap detachably connected to an end of the vessel, and a mount connected to an opposite end of the vessel, wherein the liquid drains from the vessel only when the cap is detached. An apparatus may include a vessel configured to hold a liquid, a cap detachably connected to the vessel, and a mount connected to an exterior portion of the cap, wherein the liquid drains from the vessel only when the cap is detached. The liquid may include some alcohol. The vessel may be translucent and/or may include alcohol-tolerant material. Food substance may be mounted on the mount. The vessel may have the shape of a cylinder or polygonal prism. The cap may be a twist cap, a push-down-and-turn cap, a snap-top cap, a pull-tab cap, a push-on cap, or a tear-tab cap.

### BACKGROUND

The present disclosure relates generally to an apparatus and, more particularly, to an apparatus having a vessel for holding liquid and a mount for mounting a food substance.

### SUMMARY

One aspect of an apparatus is disclosed. An apparatus may include a vessel configured to hold a liquid, a cap detachably connected to an end of the vessel, and a mount connected to an opposite end of the vessel, wherein the liquid drains from the vessel only when the cap is detached.

Another aspect of an apparatus is disclosed. An apparatus may include means for holding a liquid, means for draining the liquid, wherein the means for draining is detachably connected to an end of the means for holding, and means for mounting connected to an opposite end of the means for holding, wherein the liquid drains from the means for holding only when the means for draining is detached.

Another aspect of an apparatus is disclosed. An apparatus may include a vessel configured to hold a liquid, a cap detachably connected to the vessel, and a mount connected to an exterior portion of the cap, wherein the liquid drains from the vessel only when the cap is detached.

Another aspect of an apparatus is disclosed. An apparatus may include means for holding a liquid, means for draining the liquid, wherein the means for draining is detachably connected to an end of the means for holding, and means for mounting connected to an exterior portion of the means for draining, wherein the liquid drains from the means for holding only when the means for draining is detached.

Other aspects of apparatuses described herein will become readily apparent to those skilled in the art based on the following detailed description, wherein various aspects of apparatuses are shown and described by way of illustration. These aspects may be implemented in many different forms and its details may be modified in various ways without deviating from the scope of the present invention. Accordingly, the drawings and detailed description provided herein are to be regarded as illustrative in nature and not as restricting the scope of the claims.

### BRIEF DESCRIPTION OF THE DRAWINGS

Various aspects of apparatuses will now be presented in the detailed description by way of example, and not by way of limitation, with reference to the accompanying drawings, wherein:

FIGS. 1A-1B illustrate a first example apparatus.

FIGS. 2-3 illustrate alternative embodiments of the first example apparatus.

FIG. 4 illustrates an example twist cap.

FIG. 5 illustrates an example twist cap having a tamper-evident portion.

FIG. 6 illustrates an example push-down-and-turn cap.

FIGS. 7-8 illustrate example push-on caps.

FIG. 9 illustrates an example pull-tab cap.

FIG. 10 illustrates an example snap-top cap.

FIG. 11 illustrates an example tear-tab cap.

FIGS. 12A-12D illustrate a second example apparatus.

FIGS. 13-14 illustrate alternative embodiments of the second example apparatus.

### DETAILED DESCRIPTION

Various aspects of the disclosure will be described more fully hereinafter with reference to the accompanying drawings. This disclosure may, however, be embodied in many different forms by those skilled in the art and should not be construed as limited to any specific structure or function presented herein. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of this disclosure, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure and/or functionality in addition to or instead of other aspects of this disclosure. It should be understood that any aspect of the disclosure disclosed herein may be embodied by one or more elements of a claim.

Although particular aspects will be described herein, many variations and permutations of these aspects fall within the scope of the disclosure. Although some benefits and advantages of the preferred aspects are mentioned, the scope of the disclosure is not intended to be limited to particular benefits, uses, or objectives. The detailed description and drawings are merely illustrative of the disclosure rather than limiting, the scope of the disclosure being defined by the appended claims and equivalents thereof.

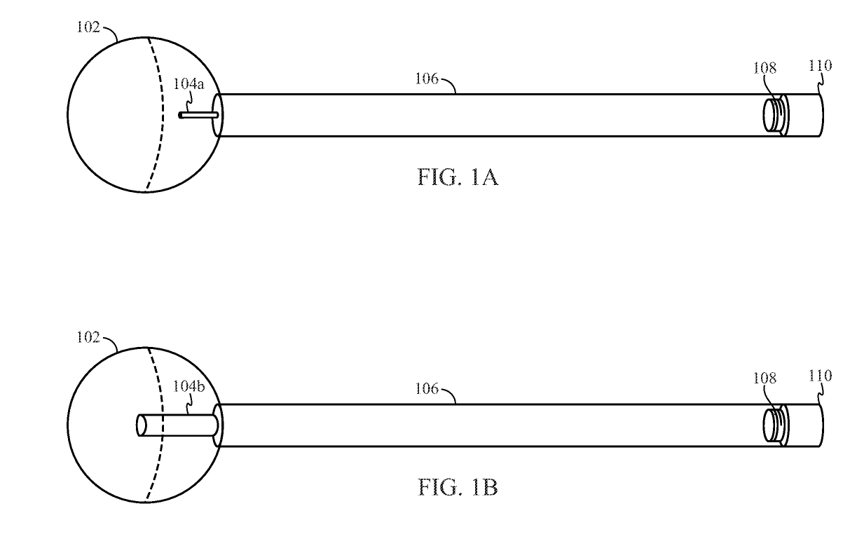

FIGS. 1A-1B illustrate an example first apparatus. The apparatus may include a vessel 106 configured to hold a liquid, a cap 110 detachably connected to an end of the vessel 106, and a mount 104a, 104b connected to an opposite end of the vessel 106. The liquid in the vessel 106 may drain from the vessel 106 only when the cap 110 is detached from the vessel 106.

The vessel 106 may provide a means for holding a liquid. The cap 110 may provide a means for draining the liquid. The means for draining the liquid (e.g., cap 110) may be detachably connected to an end of the means for holding (e.g., vessel 106). The mount 104a, 104b may provide a means for mounting. The means for mounting (e.g., mount 104a, 104b) may be connected to an opposite end of the means for holding (e.g., vessel 106) such that the liquid drains from the means for holding (e.g., vessel 106) only when the means for draining (e.g., cap 110) is detached.

A food substance 102 may be mounted on the mount 104a, 104b. For example, the food substance 102 may be candy (e.g., a lollipop), cake, chocolate, or any sugar-based food product. One of ordinary skill in the art will appreciate that other types of food substance 102 may be used without deviating from the scope of the present disclosure. The food substance 102 may be wrapped or unwrapped. If wrapped, the wrapper of the food substance 102 may be a high-crystalline polyethylene base film, a polypropylene film (e.g., a bi-axially oriented polypropylene film), a thermo-plastic polymer, a plastic with aluminum coating, wax paper, parchment paper, cellophane, foil, or any combination thereof.

The liquid in the vessel 106 may have some alcohol. For example, the liquid may be a mixed drink (e.g., a mixture of alcoholic and non-alcoholic liquids) or hard liquor (e.g., vodka, tequila). Alternatively, the liquid in the vessel 106 may be non-alcoholic (e.g., juice, espresso, energy drink/shot, liquid vitamins). The volume of liquid included in the vessel 106 may be one to two fluid ounces, although other volumes may be used without deviating from the scope of the present disclosure.

An example use of the apparatus is to detach the cap 110 from the vessel 106, to drink the liquid in the vessel 106 (from the opening created once the cap 110 has been detached), and to consume at least a portion of the food substance 102 (e.g., by licking the lollipop). Another example use of the apparatus is to consume a portion of the food substance (e.g., by lick the lollipop) and, subsequently, to detach the cap 110 from the vessel 106 and to drink the liquid therein. Alternative uses of the example apparatus will be readily apparent to one of ordinary skill in the art.

The vessel 106 may be at least in part translucent. Accordingly, light may penetrate the vessel, thereby exposing a color of the liquid in the vessel 106. A user may determine the flavor of the liquid in the vessel 106 by seeing the color of the liquid. For example, one flavor of the liquid in the vessel 106 may be known as BLOBERRY™, which has a blue color. By seeing that the liquid in the vessel 106 has a blue color, the user may determine that the flavor of the liquid is that of BLOBERRY™.

The vessel 106 may also have a label (not shown). The label may identify the name, flavor, and/or nutritional information related to the liquid and/or the food substance.

The vessel 106 and/or mount 104a, 104b may be composed of various materials. For example, the vessel 106 and/or mount 104a, 104b may be composed of various types of plastic, glass, and/or aluminum. If the liquid is alcoholic, the vessel 106 and/or mount 104a, 104b may be composed of alcohol-tolerant material. One example of alcohol-tolerant material is polyethylene terephthalate (PET) plastic. Other examples of alcohol-tolerant material will be readily apparent to one of ordinary skill in the art.

The mount 104a, 104b may have a cylindrical shape, as illustrated in FIGS. 1A-1B. The circumference and/or thickness of the cylindrically-shaped mount 104a, 104b may vary depending on the size, weight, and/or dimension of the food substance 102. Also, the length of the mount 104a, 104b may also vary depending on the size, weight, and/or dimension of the food substance 102. Accordingly, for example, the mount 104a (FIG. 1A) may be better suited for a less-heavy food substance (e.g., cake), and the mount 104b (FIG. 1B) may be better suited for a more-heavy food substance (e.g., lollipop).

The mount 104a, 104b may also include a locking portion (not shown) configured for preventing the food substance 102 from dismounting from the mount 104a, 104b. The locking portion may provide a means for locking configured to expand in an interior recess of the food substance 102 to prevent dismounting of the food substance 102. The locking portion may expand in an interior recess of the food substance. Once expanded, the locking portion may prevent the food substance from inadvertently dismounting from the mount 104a, 104b.

As illustrated in FIGS. 1A-1B, the vessel 106 may have a substantially cylindrical shape. However, one of ordinary skill in the art will appreciate that the vessel 106 may have other shapes without deviating from the scope of the present disclosure.

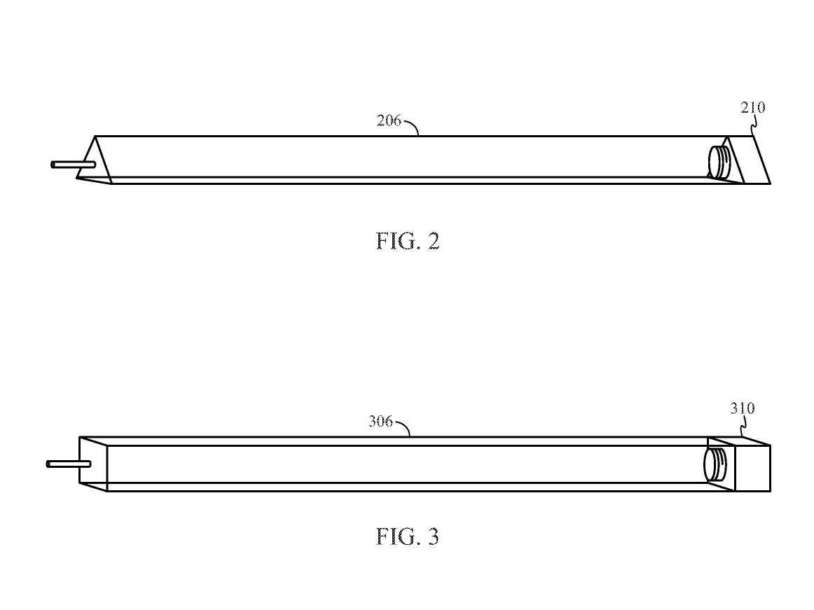

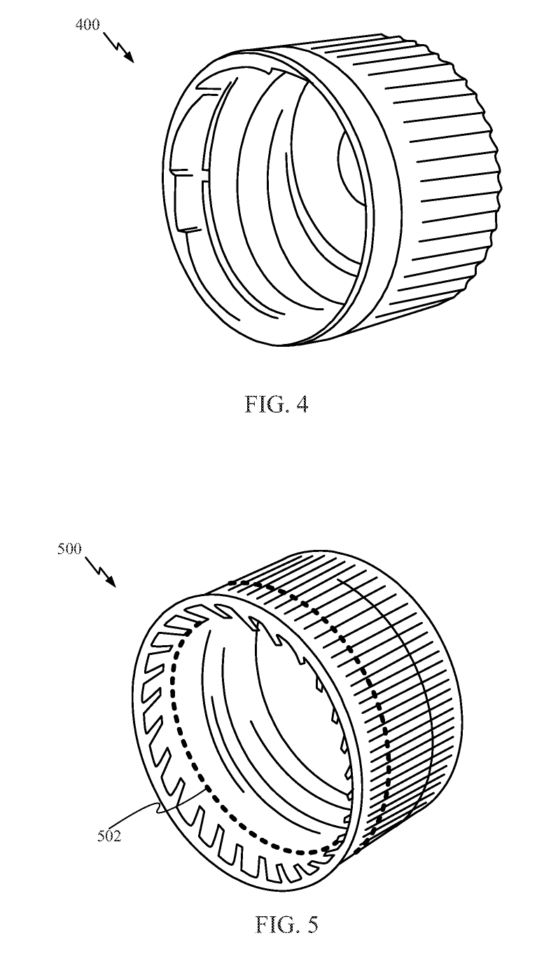

FIGS. 2 and 3 illustrate alternative shapes of the vessel 206, 306. As illustrated in FIG. 2, the vessel 206 may have the shape of a triangular prism. Alternatively, as illustrated in FIG. 3, the vessel 306 may have the shape of a quadrilateral prism. One of ordinary skill in the art will appreciate that the vessel can have other shapes (e.g., any polygonal prism) without deviating from the scope of the present disclosure.

The shape of the caps 210, 310 may correspond to the shape of the vessel 206, 306, respectively. As illustrated in FIG. 2, a triangular-shaped vessel 206 may have a triangular-shaped cap 210. Alternatively, as illustrated in FIG. 3, a quadrilateral-shaped vessel 306 may have a quadrilateral-shaped cap 310.

FIGS. 4-11 illustrate various caps. More specifically, FIG. 4 illustrates a twist cap (or, twist-on cap) 400. To detach the twist cap 400 from the vessel, the twist cap 400 may be rotated counter-clockwise. Threads located in the interior portion of the twist cap 400 may align with complimentary threads located in the exterior portion of the vessel to guide the twist cap 400 as the twist cap 400 detaches from (or attaches to) the vessel.

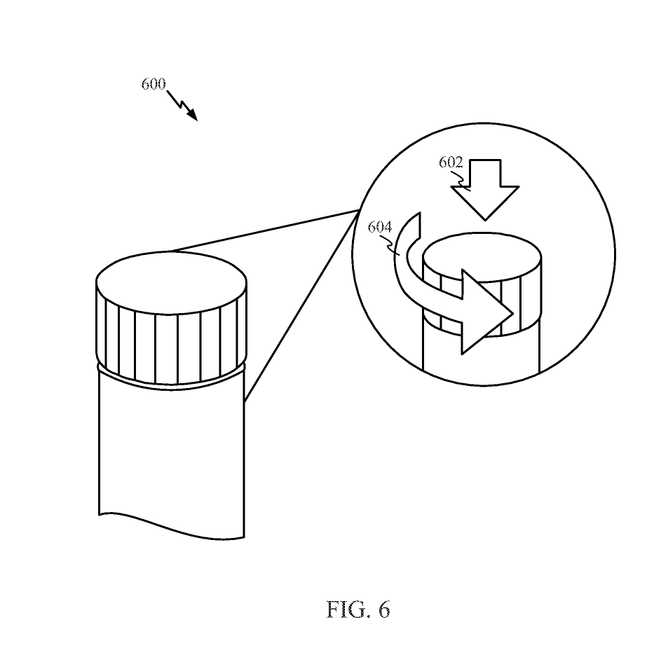

FIG. 5 illustrates a twist cap 500 with a tamper-evident seal. As the twist cap 500 is rotated counter-clockwise to detach it from the vessel, the tamper-evident seal is broken along a perforation 502. A tear along the perforation 502 informs the user that the twist cap 500 has been previously detached from the vessel. The tamper-evident seal, when unbroken, may assure the user that the liquid in the vessel has not been tampered. Although the tamper-evident seal is described with respect to the twist cap 500, one of ordinary skill in the art will appreciate that any of the other caps described herein may be configured to have a tamper-evident component.

FIG. 6 illustrates a push-down-and-turn cap 600. To remove the push-down-and-turn cap 600 from the vessel, the user must push down 602 on the cap 600 and turn/rotate 604 the cap in a counter-clockwise direction. If the cap 600 is only rotated 604 but not pushed down 602 (or, conversely, only pushed down 602 but not rotated 604), the cap 600 will not detach from the vessel. Since this cap 600 requires two sequential actions (e.g., pushing down 602 and rotating 604), a young child may not be able to easily detach the cap 600 from the vessel. Accordingly, this cap 600 may be well suited for embodiments where access to the liquid inside of the vessel is not intended for young children.

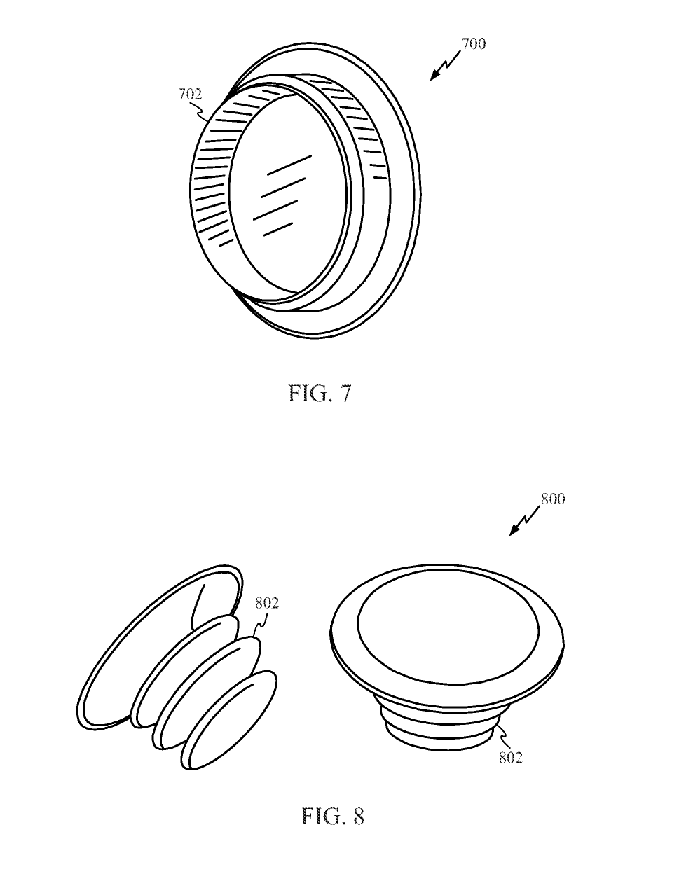

FIGS. 7 and 8 illustrate push-on caps 700, 800. With respect to FIG. 7, push-on cap 700 may have a side wall 702 configured to contact the interior of the vessel to prevent liquid from draining from the vessel when the push-on cap 700 is attached. With respect to FIG. 8, push-on cap 800 may have one or more disks 802 configured to contact the interior of the vessel in order to prevent liquid from draining from the vessel when the push-on cap 800 is attached.

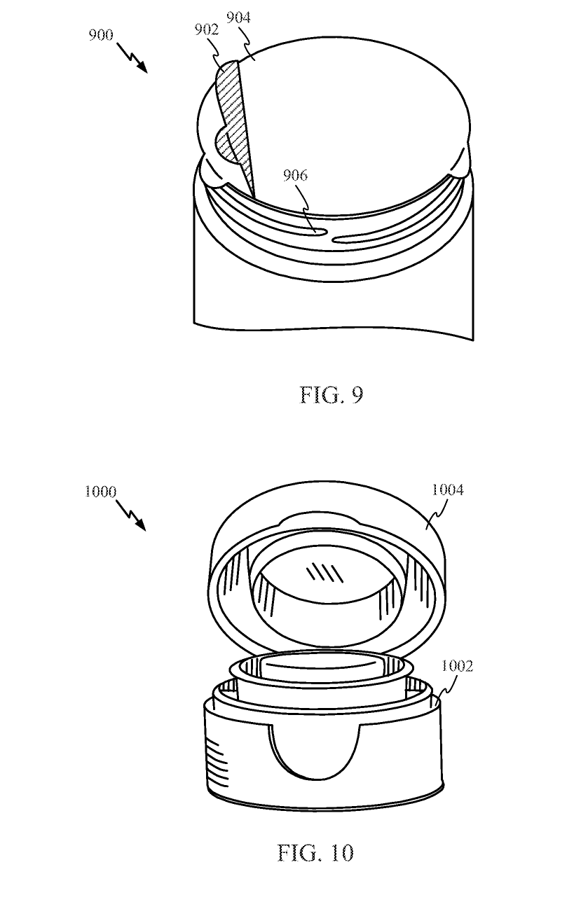

FIG. 9 illustrates a tear-tab cap 900. The tear-tab cap 900 may have a tab 902 that is attached to a cover 904. A user can pull the tab 902 in order to detach the cover 904 from the vessel. Once the cover 904 is detached from the vessel, the user can drink the liquid in the vessel. In some embodiments, the vessel may have threads 906. The threads 906 may be configured to complement threads of a twist cap (e.g., twist cap 400 in FIG. 4).

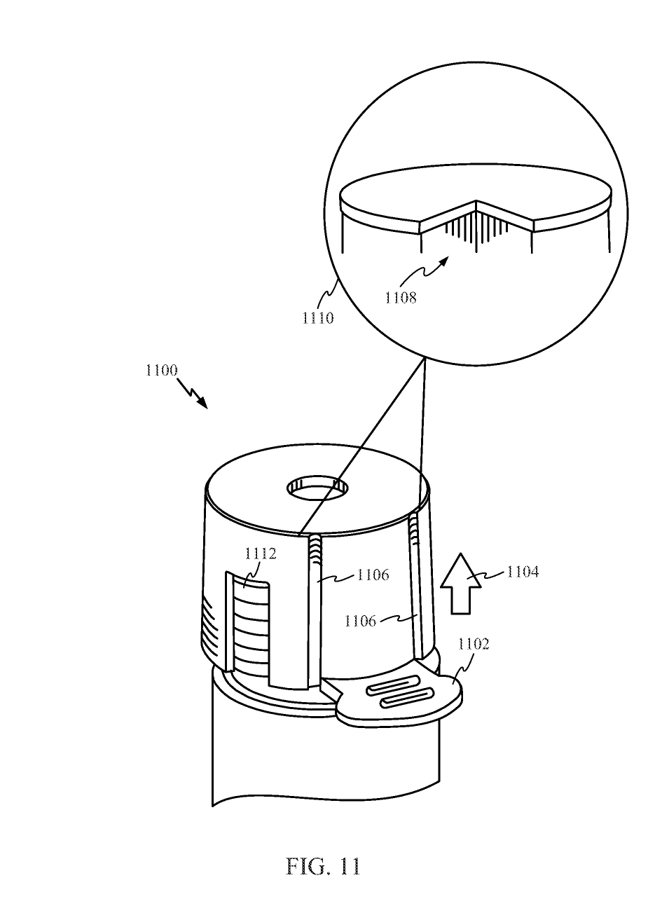

FIG. 10 illustrates a snap-top cap 1000. The snap-top cap 1000 may have a bottom portion 1002 connected to the vessel and a top portion 1004 that may be attached to the bottom portion 1002. The top portion 1004 may be detached from the bottom portion 1002 to allow the user to drink the liquid from the vessel.

FIG. 11 illustrates a tear-tab cap 1100. The tear-tab cap 1100 may have a tab 1102. A user may pull the tab 1102 in an upwards direction 1104, which causes a portion of the tear tab cap 1100 to tear along the perforations 1106. After the tear occurs along the perforations 1106, an opening 1108 is created, as illustrated in the magnified image 1110. After the opening 1108 is created, the tear-tab cap 1100 may be rotated counter-clockwise along threads 1112 in order to remove the tear-tab cap 1100 from the vessel. Before the tab 1102 is pulled upwards 1104, there is no tear along the perforations 1106, thereby indicating to a user that the liquid in the vessel has not been tampered.

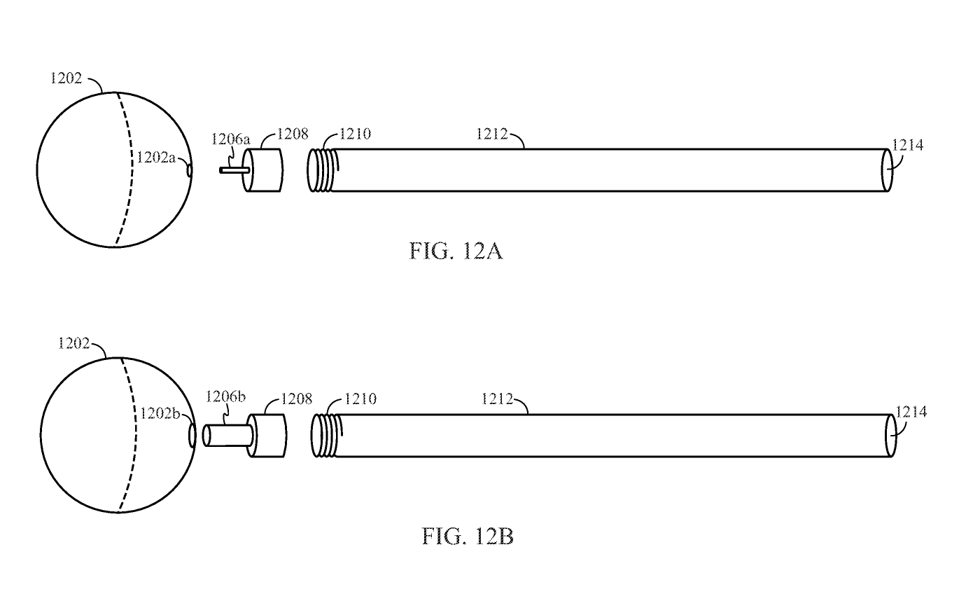

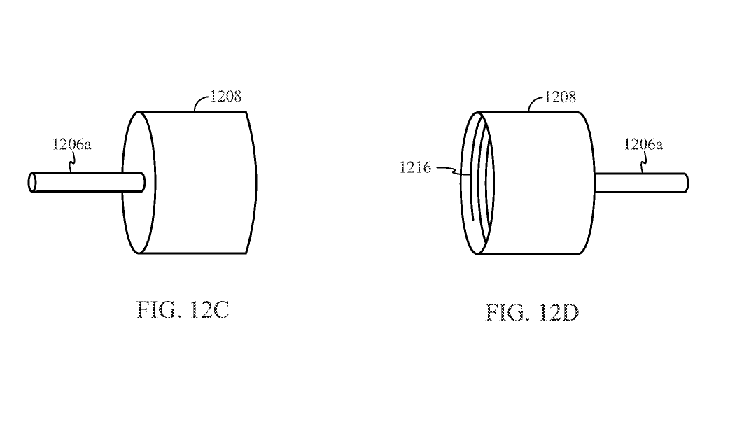

FIG. 12A-12B illustrate an example second apparatus. The apparatus may include a vessel 1212 configured to hold a liquid, a cap 1208 detachably connected to the vessel 1212, and a mount 1206a, 1206b connected to an exterior portion of the cap 1208. The liquid may drain from the vessel 1212 only when the cap 1208 is detached from the vessel 1212.

The vessel 1212 may provide a means for holding a liquid. The cap 1208 may provide a means for draining the liquid. The means for draining (e.g., cap 1208) may be detachably connected to an end of the means for holding (e.g., vessel 1212). The mount 1206a, 1206b may provide a means for mounting. The means for mounting (e.g., mount 1206a, 1206b) may be connected to an exterior portion of the means for draining (e.g., cap 1208) such that the liquid drains from the means for holding (e.g., vessel 1212) only when the means for draining (e.g., cap 1208) is detached.

The food substance 1202 is mounted on the mount 1206a, 1206b via an opening/recess 1202a, 1202b of the food substance 1202. As previously discussed with respect to the first apparatus, the mount 1206a, 1206b may have different circumferences/thicknesses and/or lengths. Accordingly, the respective opening/recess 1202a, 1202b of the food substance 1202 may vary according to the dimensions of the mount 1202a, 1202b.

Unlike the first apparatus, the second apparatus has a cap 1208 located at the same end of the vessel 1212 as the mount 1206a, 1206b. (Recall that the first apparatus had the cap located on the opposite end as the mount.) With respect to the second apparatus, the liquid drains from the vessel 1212 when the cap 1208 is detached.

FIGS. 12C and 12D illustrate magnified perspective views of the cap 1208 and mount 1206a previously illustrated in FIG. 12A.

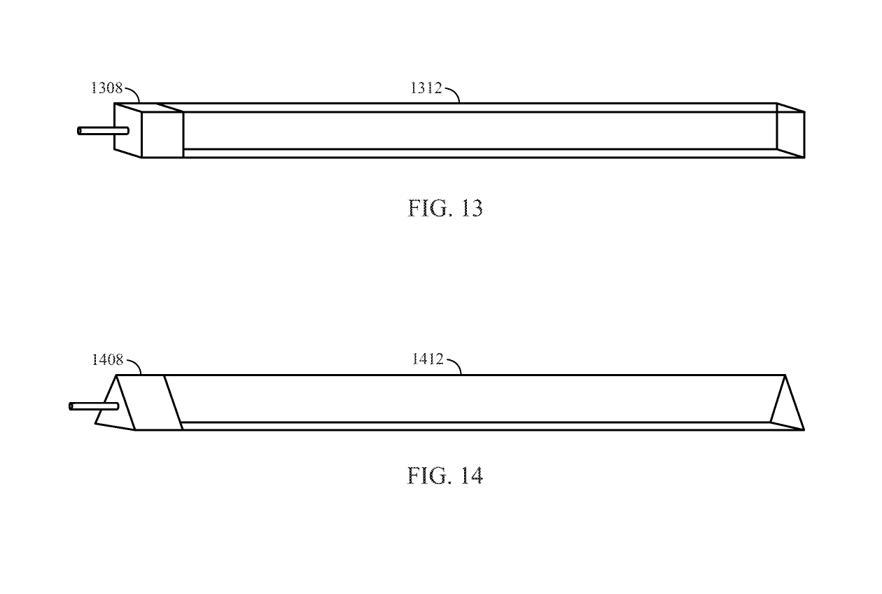

FIGS. 13-14 illustrate alternative shapes of the vessel 1312, 1412. As illustrated in FIG. 13, the vessel 1312 may have the shape of a quadrilateral prism. Alternatively, as illustrated in FIG. 14, the vessel 1412 may have the shape of a triangular prism. One of ordinary skill in the art will appreciate that the vessel 1312, 1412 may have other shapes (e.g., any polygonal prism) without deviating from the scope of the present disclosure.

The shape of the caps 1308, 1408 may correspond to the shape of the vessel 1312, 1412, respectively. As illustrated in FIG. 13, a quadrilateral-shaped vessel 1312 may have a quadrilateral-shaped cap 1308. Alternatively, as illustrated in FIG. 14, a triangular-shaped vessel 1412 may have a triangular-shaped cap 1408.

Many features of the second apparatus are similar to features of the first apparatus, which have already been described in detail. Accordingly, many of the features previously discussed with respect to the first apparatus are hereby incorporated by reference and will not be repeated with respect to the second apparatus.

The foregoing description is provided to enable any person skilled in the art to fully understand the scope of the invention. Modifications to various aspects disclosed herein will be readily apparent to those skilled in the art. Accordingly, the scope of the claims will not be limited to the various exemplary embodiments provided herein. Reference to an element in the singular is not intended to mean “one and only one” unless specifically stated as such; instead, reference to an element in the singular shall mean “one or more.” Unless specifically stated otherwise, the term “some” refers to one or more. No claim element is to be construed under the provisions of 35 U.S.C. §112(f) unless the element is expressly recited using the phrase “means for” or, in the case of a method claim, the element is recited using the phrase “step for.” The claims are not intended to be limited to the various aspects of this disclosure, but are to be accorded the full scope consistent with the language of the claims. All structural and functional equivalents to the various components of the exemplary embodiments described throughout this disclosure that are known to those of ordinary skill in the art are expressly incorporated herein by reference and are intended to be encompassed by the claims.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. An apparatus, comprising:
a vessel configured to hold a liquid;
a cap detachably connected to an end of the vessel; and
a mount connected to an opposite end of the vessel, wherein the liquid drains from the vessel only when the cap is detached.

2. The apparatus of claim 1, wherein the liquid includes at least some alcohol.

3. The apparatus of claim 1, wherein the vessel is translucent and comprises alcohol-tolerant material.

4. The apparatus of claim 3, wherein the alcohol-tolerant material comprises polyethylene terephthalate (PET) plastic.

5. The apparatus of claim 1, further comprising a food substance mounted on the mount.

6. The apparatus of claim 5, further comprising a locking portion configured to expand in an interior recess of the food substance to prevent dismounting of the food substance.

7. The apparatus of claim 1, wherein the vessel has a cylindrical shape.

8. The apparatus of claim 1, wherein the vessel has a shape of a polygonal prism.

9. The apparatus of claim 1, wherein the cap is a twist cap.

10. The apparatus of claim 1, wherein the cap is a push-down-and-turn cap.

11. The apparatus of claim 1, wherein the cap is a push-on cap.

12. The apparatus of claim 1, wherein the cap is a pull-tab cap.

13. The apparatus of claim 1, wherein the cap is a snap-top cap.

14. The apparatus of claim 1, wherein the cap is a tear-tab cap.

15. The apparatus of claim 1, wherein the cap comprises a tamper-evident portion.

16. An apparatus, comprising:
means for holding a liquid;
means for draining the liquid, wherein the means for draining is detachably connected to an end of the means for holding; and
means for mounting connected to an opposite end of the means for holding, wherein the liquid drains from the means for holding only when the means for draining is detached.

17. An apparatus, comprising:
a vessel configured to hold a liquid;
a cap detachably connected to the vessel; and
a mount connected to an exterior portion of the cap, wherein the liquid drains from the vessel only when the cap is detached.

18. The apparatus of claim 17, further comprising a food substance mounted on the mount, wherein the liquid includes at least some alcohol.

19. The apparatus of claim 17, wherein the vessel is translucent and comprises alcohol-tolerant material, and wherein the alcohol-tolerant material comprises polyethylene terephthalate (PET) plastic.

20. The apparatus of claim 17, wherein the cap comprises a tamper-evident portion.
